(19) United States
(12) Patent Application Publication
(10) Pub. No.: US 2017/0213081 A1
(43) Pub. Date: Jul. 27, 2017

(54) METHODS AND SYSTEMS FOR AUTOMATICALLY AND ACCURATELY DETECTING HUMAN BODIES IN VIDEOS AND/OR IMAGES

(71) Applicant: INTELLI-VISION, San Jose, CA (US)

(72) Inventors: Vaidhi Nathan, San Jose, CA (US); Gagan Gupta, Delhi (IN); Nitin Jindal, Faridabad (IN); Chandan Gope, Derwood, MD (US)

(73) Assignee: INTELLI-VISION

(21) Appl. No.: 15/226,610

(22) Filed: Aug. 2, 2016

Related U.S. Application Data
(60) Provisional application No. 62/235,581, filed on Nov. 19, 2015.

(51) Int. Cl. G06K 9/00

(52) U.S. Cl. CPC G06K 9/00369; G06T 7/11

(57) ABSTRACT

The present invention discloses methods and systems for detecting a human body in an image using a machine learning model. The method includes selecting one or more candidate regions from one or more regions in an image based on a pre-defined threshold. Then, a body is detected in a candidate region of the one or more candidate regions, based on a set of pair-wise constraints. The body detection further includes detection of various body parts. Thereafter, a score is computed for each detected body part and a final score for the candidate region is computed, based on the scores of the detected body parts.

### TECHNICAL FIELD

The present invention generally relates to the field of object detection, and in particular, the present invention relates to methods and systems for automatically and accurately detecting human bodies in videos and/or images using a machine learning model.

### BACKGROUND

Detecting human beings in security and surveillance videos is one of the major topics of vision research and has recently started gaining attention due to its wide range of applications. Few such examples include abnormal event detection, human gait characterization, person identification, gender classification, etc. It is challenging to process images obtained from security and surveillance systems as the images are of low resolution. Moreover, detecting human bodies is difficult as compared to rigid objects (such as trees, cars, or the like) due to a wide variety of person appearances, for example, pose, lighting, occlusion, clothing, background and other factors.

A number of solutions have been proposed in the past to address the problem of human detection. Most of the solutions use a feature transformation of pixel values using features such as Integrated Channel Features, HOG (Histogram of Oriented Gradients), SIFT (Scale-Invariant Feature Transform), LBP (Local Binary Patterns), Haar and other techniques. The transformation is then followed by discriminatively training a classifier using machine learning techniques such as SVM (Support Vector Machines), Boosted cascades and Random Forests. The features mentioned above are hand-crafted features and thus, cost high because of expert's intervention. More recently, Deep Convolutional Neural Network (DCNN) techniques have been used for human detection. The techniques offer an advantage where features are learnt as part of the training process and thus, have shown to outperform previous solutions. Limitations of DCNN based solutions include—large size of the network and used of DCNN based solutions in embedded processors for human detection.

Although the discussed solutions are accepted in the market, a common limitation across all these solutions is the performance vs accuracy trade-off. In other words, accuracy and computational burden are two main concerns. Some recent algorithms may be able to achieve better accuracy but they may not be efficient enough to run on low-power embedded devices or embedded processors. For example, as the accuracy of such solutions increases, their performance decreases to the point that acceptable accuracy is extremely hard to achieve on embedded processors. Even on processors having much more computing resources available (for example servers), it's hard to achieve real-time performance with good accuracy. With the growing use of smart devices (smart phones, smart cameras or others), there is a need to perform the task of human detection on lean processors embedded in such devices. Therefore, there is a need for efficient and accurate solutions for detecting human bodies in images and/or videos and the present invention provides such methods and systems.

### SUMMARY

An embodiment of the present invention discloses a body detection system for detecting a body in an image using a machine learning model. The body detection system comprises of a processor, a non-transitory storage element coupled to the processor and encoded instructions stored in the non-transitory storage element. The encoded instructions when implemented by the processor, configure the body detection system to detect the body in the image. The body detection system comprises a region selection unit, a body part detection unit, and a scoring unit. The region selection unit is configured to select one or more candidate regions from one or more regions in an image based on a pre-defined threshold, wherein the pre-defined threshold is indicative of the probability of finding a body in a region of the one or more regions. The body part detection unit is configured to detect a body in a candidate region of the one or more candidate regions based on a set of pair-wise constraints. The body part detection unit is further configured to: detect a first body part at a first location in the candidate region using a first body part detector of a set of body part detectors; and detect a second body part at a second location in the candidate region using a second body part detector of the set of body part detectors. The second body part detector is selected of the set of body part detectors based on a pair-wise constraint of the set of pair-wise constraints, and wherein the pair-wise constraint is determined by a relative location of the second location with respect to the first location. The scoring unit is configured to compute a score for the candidate region based on at least one of a first score and a second score, wherein the first score is determined by the detection of the first body part at the first location and the second score is determined by the detection of the second body part at the second location.

Another embodiment discloses a method for detecting a body in an image using a machine learning model. One or more candidate regions are selected, from one or more regions in an image based on a pre-defined threshold, wherein the pre-defined threshold is indicative of the probability of finding a body in a region of the one or more regions. Then, a body in a candidate region of the one or more candidate regions is detected based on a set of pair-wise constraints. Here, a first body part is detected at a first location in the candidate region using a first body part detector of a set of body part detectors. Similarly, a second body part is detected at a second location in the candidate region using a second body part detector of the set of body part detectors. The second body part detector is selected of the set of body part detectors based on a pair-wise constraint of the set of pair-wise constraints, and wherein the pair-wise constraint is determined by a relative location of the second location with respect to the first location. Finally, a score is computed for the candidate region based on at least one of a first score and a second score, wherein the first score is determined by the detection of the first body part at the first location and the second score is determined by the detection of the second body part at the second location.

An additional embodiment describes a human body detection system for detecting a human body in an image using a machine learning model. The human body detection system comprises of a processor, a non-transitory storage element coupled to the processor and encoded instructions stored in the non-transitory storage element. The encoded instructions when implemented by the processor, configure the body detection system to detect the human body in the image. The body detection system comprises a region selection unit, a body part detection unit and a scoring unit. The region selection unit is configured to select one or more candidate regions from one or more regions in an image based on a pre-defined threshold. The body part detection unit is configured to detect a human body in a candidate region of the one or more candidate regions based on a set of pair-wise constraints. The body part detection unit is further configured to: detect a first body part at a first location in the candidate region using a first body part detector of a set of body part detectors; and detect a second body part at a second location in the candidate region using a second body part detector of the set of body part detectors. The second body part detector is selected of the set of body part detectors based on a pair-wise constraint of the set of pair-wise constraints, and wherein the pair-wise constraint is determined by a relative location of the second location with respect to the first location. The scoring unit is configured to compute a score for the candidate region based on at least one of a first score and a second score, wherein the first score is determined by the detection of the first body part at the first location and the second score is determined by the detection of the second body part at the second location.

### BRIEF DESCRIPTION OF DRAWINGS

FIG. 1 illustrates an exemplary environment in which various embodiments of the present invention can be practiced.

FIG. 2 shows an overall system including various components for detecting human bodies, according to an embodiment of the present invention.

FIG. 3 shows an exemplary human body with various body parts.

FIG. 4 shows an exemplary output using Directional Weighted Gradient Histogram (DWGH), according to an embodiment of the invention.

FIG. 5 is a method flowchart for detecting human bodies, according to an embodiment.

### DETAILED DESCRIPTION OF DRAWINGS

The present invention will now be described more fully with reference to the accompanying drawings, in which embodiments of the present invention are shown. However, this invention should not be construed as limited to the embodiments set forth herein. Rather, these embodiments are provided so that this invention will be thorough and complete, and will fully convey the scope of the present invention to those skilled in the art. Like numbers refer to like elements throughout.

### Overview

The primary purpose of the present invention is to develop improved algorithms and accordingly, enable devices/machines/systems to automatically and accurately detect human bodies in images and/or videos. Specifically, the present invention uses deformable part-based model on HoG features combined with latent SVM techniques, to detect one or more human bodies in an image. Part-based human detection localizes various body parts of a human body through programming of visual features. And, the part-based detection uses root filters and part filters (discussed below). Further, the invention focuses on two aspects—(i) training and (ii) detection. Training is an offline step where machine learning algorithms (DCNN) are trained on a training data set to learn human and non-human from various images. The step of detection uses one or more machine learning models to classify human and non-human regions. This is performed using a pre-processing step of identifying potential regions for human and a post-processing step of validating the identified regions. In the detection step, part based detectors are implemented on the identified region by the root filter to localize each human part.

As mentioned above, the present invention uses improved deformable part-based models/algorithms to address the problems existing in the art. More particularly, the invention uses part filters together with deformable models instead of a single rigid model, thus, methods and systems of the invention are able to model the human appearance accurately and in a more robust manner as compared to the existing solutions. Various examples of the filters include typical HoG or HoG-like. The model is then trained by a latent SVM (Support Vector Machines) formulation where latent variables usually specify object (human in this case) configurations such as relative geometric positions of parts of a human. For example, a root filter is trained for the entire body region and part filters are trained within the region of root filter using latent SVM techniques. The model includes root filters which cover the object and part models that cover smaller parts of the object. The part models in turn include their respective filters, relative locations and a deformation cost function. To detect a human in an image, an overall score is computed for each root location at several scales, and the high score locations are considered as candidate locations for the human. In this manner, the present invention leverages basic algorithms to achieve better accuracy and performance.

### Exemplary Environment

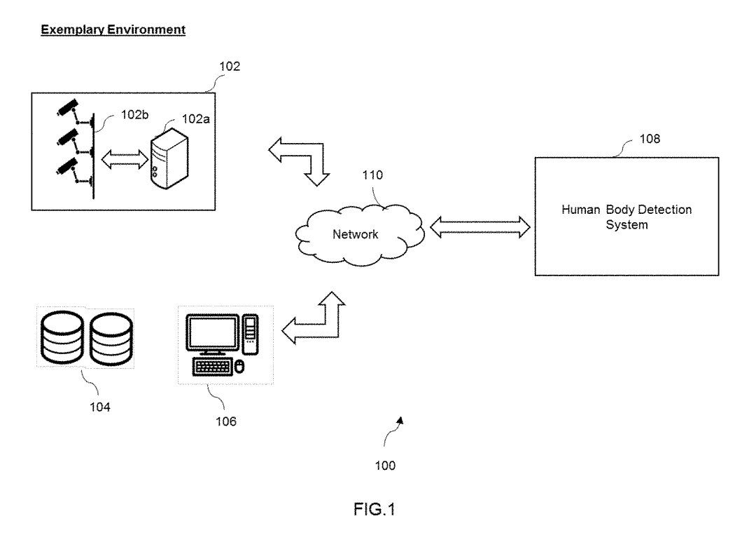

FIG. 1 illustrates an exemplary environment 100 in which various embodiments of the present invention can be practiced. While discussing FIG. 1, references to other figures may be made. The environment 100 includes a real-time streaming system 102, a video/image archive 104, a computer system 106 and a human body detection system 108. The real-time streaming system 102 includes a video server 102a, and a plurality of video/image capturing devices 102b installed across various locations. Examples of such locations include, but are not limited to, roads, parking spaces, garages, toll booths, outside residential areas, outside office spaces, outside public places (such as malls, recreational areas, museums, libraries, hospitals, police stations, fire stations, schools, colleges), and the like. The video/image capturing devices 102b include, but are not limited to, Closed-Circuit Television (CCTVs) cameras, High Definition (HD) cameras, non-HD cameras, handheld cameras, or any other video/image grabbing units. The video server 102a of the real-time streaming system 102 is configured to receive a dynamic imagery or video footage from the video/image capturing devices 102b, and transmit the associated data to the human body detection system 108. In an embodiment, the video server 102a may maintain the dynamic imagery or video footage as received from the video/image capturing devices 102b.

The video/image archive 104 is a data storage that is configured to store pre-recorded or archived videos/images. The videos/images may be stored in any suitable formats as known in the art or developed later. The video/image archive 104 includes a plurality of local databases or remote databases. The databases may be centralized and/or distributed. In an alternate scenario, the video/image archive 104 may store data using a cloud based scheme. Similar to the real-time streaming system 102, the video/image archive 104 may transmit image data to the human body detection system 108.

The computer system 106 is any computing device remotely located from the human body detection system 108, and is configured to store a plurality of videos/images in its local memory. In an embodiment, the computer system 106 may be replaced by one or more of a computing server, a mobile device, a memory unit, a handheld device or any other similar device. In an embodiment of the present invention, the real-time streaming system 102 and/or the computer system 106 may send data (input frames) to the video/image archive 104 for storage and subsequent retrieval. The real-time streaming system 102, the video/image archive 104, and the computer system 106 are communicatively coupled to the human body detection system 108 via a network 110.

As shown, the human body detection system 108 may be part of at least one of a surveillance system, a security system, a traffic monitoring system, a home security system, a toll fee system or the like. In another embodiment, the human body detection system 108 may be a separate entity configured to detect human bodies. The human body detection system 108 is configured to receive data from any of the systems including: the real-time streaming system 102, the video/image archive 104, the computing system 106, or a combination of these. The data may be in form of one or more video streams and/or one or more images. In case the data is in the in the form of video streams, the human body detection system 108 converts each stream into a plurality of static images or frames before processing. In case the data is in the form of image sequences, the human body detection system 108 processes the image sequences and generates an output in the form of a detected person.

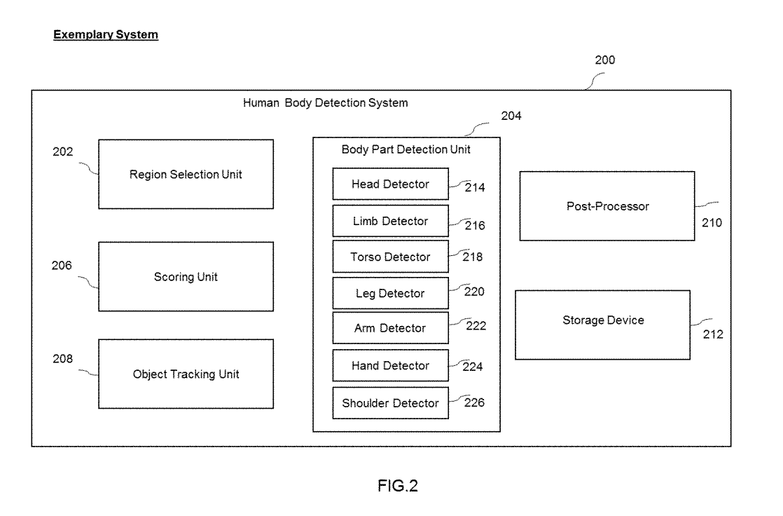

In detail, the human body detection system 108 processes the one or more received images (or frames of videos) and executes techniques for detecting human bodies. The system 108 first processes each of the received images to identify one or more human regions of one or more regions in the image. Then, the system 108 identifies a root of a body in a human region using root filters and identifies one or more body parts of the body based on a set of pair-wise constraints. The body parts are detected using one or more body part detectors. The system 108 then calculates scores of detected body parts and finally calculates an overall score based on one or more scores associated with the body parts. While performing human detection, the human body detection system 108 takes into account occlusion, illumination or other such conditions. More technical and structural details of the human body detection system 108 will be covered in subsequent figures FIGS. 2-5.

As shown, the network 110 may be any suitable wired network, wireless network, a combination of these or any other conventional network, without limiting the scope of the present invention. Few examples may include a LAN or wireless LAN connection, an Internet connection, a point-to-point connection, or other network connection and combinations thereof. The network 110 may be any other type of network that is capable of transmitting or receiving data to/from host computers, personal devices, telephones, video/image capturing devices, video/image servers, or any other electronic devices. Further, the network 110 is capable of transmitting/sending data between the mentioned devices. Additionally, the network 110 may be a local, regional, or global communication network, for example, an enterprise telecommunication network, the Internet, a global mobile communication network, or any combination of similar networks. The network 110 may be a combination of an enterprise network (or the Internet) and a cellular network, in which case, suitable systems and methods are employed to seamlessly communicate between the two networks. In such cases, a mobile switching gateway may be utilized to communicate with a computer network gateway to pass data between the two networks. The network 110 may include any software, hardware, or computer applications that can provide a medium to exchange signals or data in any of the formats known in the art, related art, or developed later.

Similar to the network 110, the real-time streaming system 102, the video/image archive 104, and the computer system 106 are connected to each other via any suitable wired, wireless network or a combination thereof (although not shown).

### Exemplary Overall System

FIG. 2 illustrates an overall system 200 configured for detecting a human body according to an embodiment of the invention. As shown, the system 200 includes a region selection unit 202, a body part detection unit 204, a scoring unit 206, an object tracking unit 208, a post-processor 210 and a storage device 212. The body part detection unit 204 further includes a head detector 214, a limb detector 216, a torso detector 218, a leg detector 220, an arm detector 222, a hand detector 224, and a shoulder detector 226. In addition, the system 200 includes other components (although not shown) such as an input unit, and a pre-processor. Each of the components 202-226 are connected to each other using suitable network protocols or via a communication bus as known in the art or later developed protocols. Each of the components 202-226 will be discussed in detail below.

The input unit is configured to receive an input from one or more systems including the real-time streaming system 102, the video/image archive 104 and the computer system 106. The input may be one or more images and/or videos. In an embodiment of the invention, the input unit may receive a video stream (instead of an image), wherein the video stream is divided into a sequence of frames. For simplicity, further details will be discussed with respect to an image/frame. In an embodiment, the input unit is configured to remove noise from the image before further processing. The images may be received by the input unit automatically at pre-defined intervals. For example, the input unit may receive the images after every 1 hour or twice a day, from the systems 102, 104 and 106. In another scenario, the images may be received when requested by the human body detection system 200 or by any other systems.

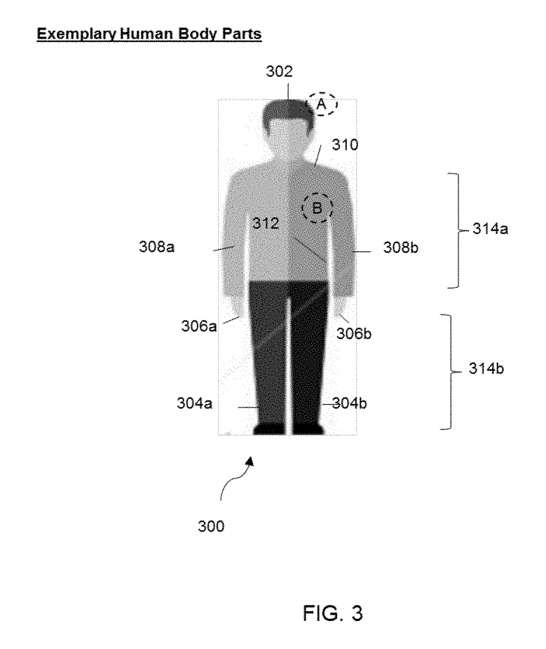

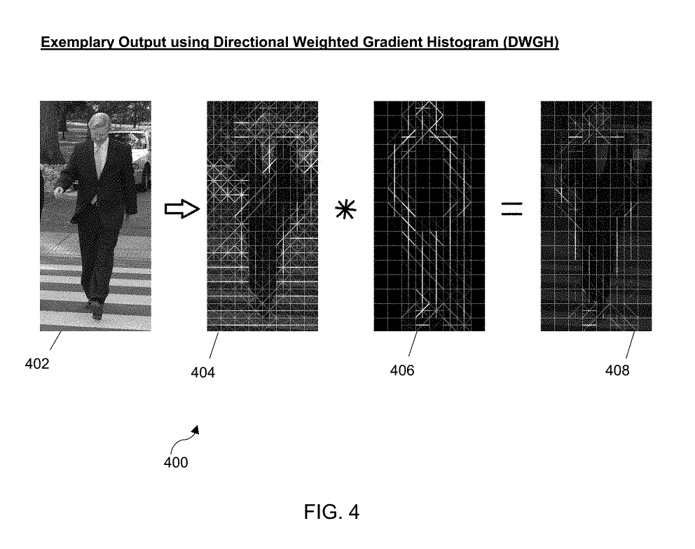

In an embodiment, the image is captured in real-time by the video/image capturing devices 102b. In another embodiment of the invention, the image may be previously stored in the video/image archive 104 or the computer system 106. The image as received may be in any suitable formats as known in the art or developed later. The image includes objects such as human bodies, cars, trees, animals, buildings, any articles and so forth. Further, the image includes one or more regions that include human bodies and non-human objects. Here, the regions that include human bodies are called as candidate regions. An exemplary image having a human body such as 402 is shown in FIG. 4. In addition, an exemplary human 300 with body parts is shown in FIG. 3. Referring to FIG. 3, the human 300 has one or more body parts such as head 302, legs 304a and 304b, hands 306a and 306b, arms 308a and 308b, shoulder 310, torso 312, and limbs 314a, and 314b.

In an embodiment, the system 200 may include a pre-processor configured to process the image to eliminate pixels that are not likely to be a part of a human body.

On receiving the image, the input unit transmits the image to the region selection unit 202. The region selection 202 unit is configured to select one or more candidate regions from the one or more of regions in the image based on a pre-defined threshold. The pre-defined threshold is indicative of the probability of finding a human body in a region of the one or more regions. Here, the candidate regions refer to bounding boxes which are generated using machine learning based detector or algorithms. These algorithms run fast and generate candidate regions with false alarms (i.e., the regions which are to be eliminated). The algorithms also generate candidate regions having the probability of finding a human body.

In an embodiment of the present invention, the region selection unit 202 executes a region selection algorithm to select the one or more candidate regions. The region selection algorithm is biased to give a very low false negative (meaning if a region includes a human, there is very low probability that the region will be rejected) and possibly high false positive (meaning if a region does not have a human, the region may be selected). The region selection algorithm is fast such that it quickly selects the candidate regions whose number is significantly smaller than all possible regions in the image (such as those used by sliding window technique). Various algorithms may be used for candidate region selection such as motion based, simple HOG+SVM based and foreground pixels' detection based algorithms. Once the one or more candidate regions are selected, the selected regions are sent to the body part detection unit 204 for further processing.

As shown, the body part detection unit 204 is configured to detect a human body in a candidate region of the one or more candidate regions based on a set of pair-wise constraints. The body part detection unit 204 performs parts-based detection of the human body such as head, limbs, arms, legs, shoulder, torso, and hands. To this end, the body part detection unit 204 includes a set of body part detectors for detecting respective parts of the body. For example, the unit 204 includes the head detector 214, the limb detector 216, the torso detector 218, the leg detector 220, the arm detector 222, the hand detector 224 and the shoulder detector 226. As evident from the names, the head detector 214 detects a head of the human body, the limb detector 216 detects limbs (upper and lower limbs), the torso detector 218 detects a torso, the leg detector 220 detects legs (left and right), the arm detector 222 detects two arms of the human body, the hand detector 224 detects two hands of the body and the shoulder detector 226 detects the shoulder of the body. In an embodiment, the body parts detectors are based on Deep Convolution Neural Networks (DCNN).

In detail, the body part detection unit 204 detects a first body part at a first location in the candidate region using a first body part detector of the set of body part detectors. The first body part is a root of the body, for example, a head of the body. The body part detection unit 204 further detects a second body part at a second location in the candidate region using a second body part detector of the set of body part detectors. The second body part detector is selected of the set of body part detectors based on a pair-wise constraint of the set of pair-wise constraints. The pair-wise constraint is determined by a relative location of the second location with respect to the first location.

In an example, it may be considered that the head is the root of the body, and thus, the head is the first body part that gets detected using the head detector 214. The head is located at a location A (i.e., the first location). The body part detection unit 204 selects a second body part which is relatively located at a second location B with respect to the first location A (see FIG. 3) and an example of such second body part may include limbs. Other examples of the second body part may include a shoulder, and arms.

It may be noted that the body part detection unit 204 does not implement all detectors, however, decision of running the detectors 214-226 may be condition-based. For example, the head detector 214 may be run first and if the head is detected, then other body parts detectors 216-226 may be run in appropriate regions relative to the head. The condition based implementation helps reduce the number of times the detectors need to be run. Further, the body parts-based network helps reduce the size of the network and thus, gives better performance as compared to full body/person based network. Then, the detected first body part and the second body part are sent to the scoring unit 206 for further processing.

The scoring unit is 206 configured to compute a score for the candidate region based on at least one of a first score and a second score. The first score corresponds to the score of the first body part, while the second score corresponds to the score of the second body part. The first score is determined based on the detection of the first body part at the first location and the second score is determined based on the detection of the second body part at the second location. Based on the first score and the second score, an overall score is computed for the detected human body. In an embodiment, the overall score may be a summation of the first score and the second score. In another embodiment, the overall score may be a weighted summation of the first score and the second score.

In an embodiment, the body part detection unit 204 may further implement one or more body parts detectors such as the leg detector 220, the arm detector 222, and so on till the complete human body is detected. Based on the detected body parts, the overall score may be computed.

As depicted, the object tracking unit 208 is configured to track the body across a plurality of frames. The tracking may be performed based on one or more techniques including a MeanShift technique, an Optical Flow technique, more recently, online learning based techniques strategies and bounding box estimation.

In an embodiment, the body may be tracked using the information contained in the current frame and one or more previous/next frames and may accordingly perform an object correspondence. To this end, a bounding box estimation process is executed, wherein the bounding box (or any other shape containing the object) of an object in the current frame is compared with its bounding box in the previous frame(s) and a correspondence is established using a cost function. The bounding box techniques represent region and location for the entire body of each human while maintains the region and location of body parts.

In another embodiment, feature/model based tracking may be performed. According to this embodiment, a pair of objects that include the minimum value in the cost function is selected by the object tracking unit 208. The bounding box of each tracked object is predicted based on maximizing a metric in a local neighborhood. This prediction may be made using techniques such as but not limited to, optical flow, mean shift, and/or dense-sampling search, and is based on features such as Histogram of Oriented Gradients (HoG) color, Haar-like features, and the like.

Once tracking is complete, the object tracking unit 208 communicates with the post-processor 210 for further steps. The post-processor 210 is configured to validate the detected body in the candidate region. The body is validated based on at least one of the group comprising a depth, a height and an aspect ratio of the body. In another embodiment, the validation may be performed based on generic features such as color, HoG, SIFT, Haar, LBP, and the like.

The shown storage device 212 is configured to store all data received from the systems 102, 104 and 106 of FIG. 1 as well as data processed by each component 202, 204, 206, 208, 210, 214, 216, 218, 220, 222, 224, and 226. The data may be stored in any suitable format for subsequent retrieval.

In an embodiment, the storage device 212 may include a training database including pre-loaded human images for comparison to the image during the human body detection process. The training database may store human images of different positions and sizes. Few exemplary formats of storing such images include, but not limited to, GIF (Graphics Interchange Format), BMP (Bitmap File), JPEG (Joint Photographic Experts Group), TIFF (Tagged Image File Format), and so forth. The human images may be positive image clips for positive identification of objects as human bodies and negative image clips for positive identification of objects as non-human bodies. Using the stored/training images, a machine learning model is built and applied while detecting human bodies.

It may be understood that in an embodiment of the present invention, the components 202-226 may be in the form of hardware components, while in another embodiment, the components 202-226 may be in the form of software entities/modules. In yet another embodiment of the present invention, the components may be a combination of hardware and software modules. The components 202-226 are configured to send data or receive data to/from each other by means of wired or wireless connections. In an embodiment of the invention, one or more of the units 202-226 may be remotely located. For example, the storage device 212/database may be hosted remotely from the human body detection system 200, and the connection to the device 212 can be established using one or more wired/wireless connections.

In an embodiment, the human body detection system 200 may be a part of at least one of the group comprising a mobile phone, a computer, a server, or a combination thereof.

The below sections primarily cover significance of improved algorithms/components/processes as implemented in the present invention along with the required technical details.

### Detailed Algorithm—Directional Weighted Gradient Histogram Feature

The present invention introduces a scheme Directional Weighted Gradient Histogram feature (DWGH) for detecting the human body in the image. The scheme DWGH is implemented to learn, better discrimination between positive and negative images.

In DWGH feature, a weighted multiplication w (i) is learnt for each directional gradient g (i) in HOG. For example, in HOG, 8 directional signed gradient histogram features are given equal weights. Then all positive image sets/samples are considered and broken into a grid of 4×8 HOG cell grid, which is termed as HOG (p, q). The approach further evaluates HOG (p, q) feature over all positive images from the set {1, 2, 3 . . . b} where b is total number of positive image samples. Thereafter, Directional Weighted Gradient—DWG (p, q) is computed as a normalized addition of all HOG feature vectors computed at (p, q) grid location from positive images {1, 2, 3 . . . b} and normalization is performed again in the end. From the above, a matrix of 4×8 DWG (p, q) is achieved, where p={l, 2, 3, 4}, q={l, 2, 3 . . . 8}.

For every HOG feature, dot product is computed with its corresponding DWG (p, q) based on its spatial location (See 404 and 406 of FIG. 4). This step helps suppress the weights of gradients in HOG that are not playing role at certain grid locations in a pedestrian image, for example (see 402 of FIG. 4). For example, near the legs region, it is observed that horizontal gradients DWG (p, q) had higher weights as legs are vertical, whereas in shoulder region vertical gradients DWG (p, q) had higher weights. With the help of {4×8 DWG(p,q)}, Directional Weighted Gradient Histogram feature (DWGH} (marked as 408) is obtained that is able to suppress the background edges which arise from cluttered background and further boosts the edges of pedestrian over the body contour. The process (indicated as 400) of generation of DWGH is shown in FIG. 4. The approach increases the discrimination between positives and negatives especially for positives (human bodies) in cluttered background. Also, the approach makes the task easier for a machine learning algorithm to efficiently learn the discriminative model.

### Filters

To compute the response of filters, convolution in the spatial domain is replaced with multiplication in the Fourier domain i.e. the filtering is done using Fast Fourier Transform (FFT) of the feature map and the filters. This provides a significant performance improvement considering that the filtering needs to be performed at multiple scales.

### Latent Support Vector Machines (SVM) Variables

Latent SVM enables the use of part positions as latent variables. The approach further introduces latent variables for the pose of the person (standing, sitting, squatting) and parts occlusion (a part may be visible or not). The introduction of these variables enhances the robustness of the algorithm and improves the detection accuracy. Similarly, other latent variables can be added to the model formulation.

### Pair-Wise Parts Constraints

To speed up the process of searching of the body parts, the present invention introduces a scheme of pair-wise parts constraints. This means that in addition to relative location of body parts with respect to the root, parts need to satisfy pair-wise constraints with respect to each other. For example, if a good candidate for head is detected, then the search space may be reduced for other body parts such as limbs with respect to the head.

### Candidate Regions in Motion

To further speed up the detection process and to also reduce false positives, it is considered that there is a high probability that human bodies are present in the regions in motion as opposed to static regions. Using this, the detection regions in the frame are restricted to only those that regions indicating motion. In alternate scenario, higher overall matching scores are required in static regions thus, reducing false positives.

### Object Tracking

To further optimize the performance and eliminate redundant running of the detection algorithm, tracking of detected human bodies is performed in subsequent frames using object tracking algorithms. Some examples may include, but not limited to, optical flow, mean shift or any other object tracking algorithm.

### Post-Processing

The invention also utilizes post-processing techniques on the detected human body in the image to reduce false positives. One such example includes validating the detected region based on size and depth. Human bodies standing farther away may appear smaller, hence it is expected that if the bottom point of the detected bounding box is above a certain height in the image, then the height of the bounding box needs to be below a certain value.

### Deep Convolution Neural Networks (DCNN)

Deep Convolution Neural Networks (DCNN) recently have been shown to surpass previous state-of-the-art accuracies on a variety of object recognition problems. The success has primarily been due to the fact that DCNN do not use any hand-crafted features such HOG, LBP, SIFT etc. but instead learn an effective feature transformation from the data itself. To overcome the limitations and have an efficient embeddable human detection algorithm, DCNN based approach is followed in the present invention.

### Exemplary Method Flowchart

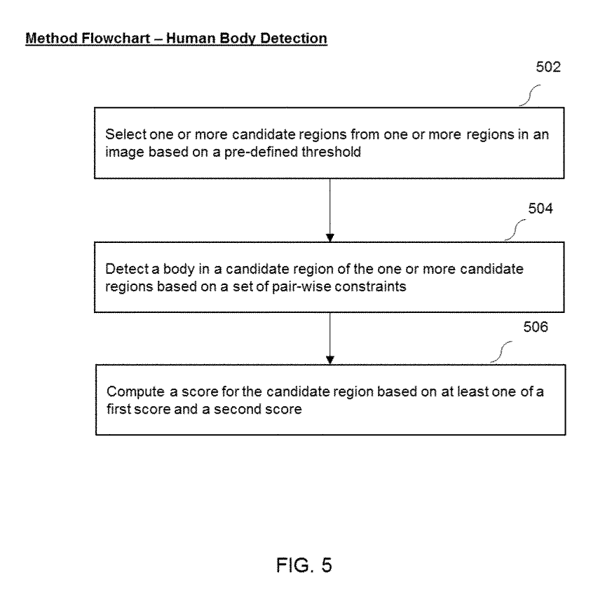

FIG. 5 illustrates an exemplary method flowchart for detecting a body in an image based on a machine learning model. The method focuses on using deformable parts-based models for detecting human bodies, where one or more features are extracted for each part and are assembled to form descriptors based on pair-wise constraints.

Initially, the method starts with receiving an image from a remote location such as systems 102, 104 and/or 106. The image may be a still image or may be a frame in a video. The image includes one or more regions, wherein the one or more regions include regions with human bodies and regions with non-human objects such as cars, roads and trees. The regions with human bodies are called as candidate regions. In a preferred embodiment, the candidate region is a region in motion of a video.

On receiving the image, at 502, one or more candidate regions in the image are selected from the one or more regions based on a pre-defined threshold. The pre-defined threshold indicates the probability of finding a body in a region of the one or more regions.

Then, a body in a candidate region of the one or more candidate regions is detected based on a set of pair-wise constraints, at 504. The detection is performed for various body parts. Various detectors used for detecting respective body parts include, head detector, a limb detector, a torso detector, a leg detector, an arm detector, a hand detector and a shoulder detector.

Here, a first body part at a first location in the candidate region is detected using a first body part detector. Similar to the first body part, a second body part is detected at a second location in the candidate region using a second body part detector. The second body part detector is selected based on a pair-wise constraint of the set of pair-wise constraints. The pair-wise constraint is determined by a relative location of the second location with respect to the first location. Also, here, the first body part is considered as root of the body and once the root is found, the next part of the body which is relatively located at the second location is found.

At 506, a score for the candidate region is calculated based on at least one of the first score and the second score. The first score is determined based on detection of the first body part at the first location. Similarly, the second score is determined based on detection of the second part at the second location.

In an embodiment, the body is tracked across a plurality of frames of the video.

The body as detected in the candidate region is further validated. The validation is performed based on one or more parameters such as a depth, a height and an aspect ratio of the body.

In an embodiment, once the step of validation is completed, an output image is generated. The output image is then transmitted to an output device. Various examples of the output device may include, a digital printer, a display device, an Internet connection device, a separate storage device, or the like.

In an embodiment, the detected human body may be stored for further retrieval by one or more agents, users, or entities. Examples include, but are not limited to, law enforcement agents, traffic controllers, residential users, security personnel, surveillance personnel, and the like. The retrieval/access may be made by use of one or more devices. Examples of the one or more devices include, but are not limited to, smart phones, mobile devices/phones, Personal Digital Assistants (PDAs), computers, work stations, notebooks, mainframe computers, laptops, tablets, internet appliances, and any equivalent devices capable of processing, sending and receiving data.

In an embodiment of the invention, a surveillance agent accesses the human body detection system 108 using a computer. The surveillance agent inputs an image on an interface of the computer. The input image is processed by the human body detection system 108 to identify one or more human bodies in the image. The detected human bodies may then be used by the agent for various purposes.

The present invention may be implemented for application areas including, but not limited to, security, surveillance, automotive driver assistance, automated metrics and intelligence, smart vehicles/machines effective traffic control and security applications.

The present invention provides methods and systems for automatically detecting human bodies in images and/or videos. The invention uses techniques that permit the human body detection system to be insensitive to partial occlusions, lighting conditions, etc. The invention uses efficient algorithms for region selection and body parts detection. Moreover, the invention can be implemented for low-power embedded devices or embedded processors.

The human detection 108 as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the method of the present invention.

The computer system comprises a computer, an input device, a display unit and the Internet. The computer further comprises a microprocessor. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The storage elements may also hold data or other information as desired. The storage element may be in the form of an information source or a physical memory element present in the processing machine.

The set of instructions may include one or more commands that instruct the processing machine to perform specific tasks that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

Embodiments described in the present disclosure can be implemented by any system having a processor and a non-transitory storage element coupled to the processor, with encoded instructions stored in the non-transitory storage element. The encoded instructions when implemented by the processor configure the system to detect human bodies discussed above in FIGS. 1-5. The system shown in FIGS. 1 and 2 can practice all or part of the recited method (FIG. 5), can be a part of the recited systems, and/or can operate according to instructions in the non-transitory storage element. The non-transitory storage element can be accessed by a general purpose or special purpose computer, including the functional design of any special purpose processor. Few examples of such non-transitory storage element can include RAM, ROM, EEPROM, CD-ROM or other optical disk storage or other magnetic. The processor and non-transitory storage element (or memory) are known in the art, thus, any additional functional or structural details are not required for the purpose of the current disclosure.

For a person skilled in the art, it is understood that these are exemplary case scenarios and exemplary snapshots discussed for understanding purposes, however, many variations to these can be implemented in order to detect objects (primarily human bodies) in video/image frames.

In the drawings and specification, there have been disclosed exemplary embodiments of the present invention. Although specific terms are employed, they are used in a generic and descriptive sense only and not for purposes of limitation, the scope of the present invention being defined by the following claims. Those skilled in the art will recognize that the present invention admits of a number of modifications, within the spirit and scope of the inventive concepts, and that it may be applied in numerous applications, only some of which have been described herein. It is intended by the following claims to claim all such modifications and variations which fall within the true scope of the present invention.

What is claimed is:

1. A method for training a machine learning based classifier to be used with an object detection system, the object detection system being configured to detect one or more objects in an input image, the method comprising:
receiving one or more training images, wherein the one or more training images comprises of a plurality of positive training images;
dividing each positive training image of the plurality of positive training images into a cell grid of size p*q, wherein each positive training image comprises of p*q cells;
computing a histogram of gradients (HOG) feature descriptor for each of the p*q cells in each of the plurality of positive training images, wherein HOG (p,q) for a positive training image represents HOG feature descriptor computed for a cell location (p,q) of the positive training image;
computing a directional weighted gradient DWG (p,q) by adding HOG (p,q) corresponding to each of the plurality of positive training images;
computing a directional weighted gradient histogram (DWGH) feature for each of the p*q cells in each of the plurality of positive training images, wherein DWGH (p,q) for a positive training image is computed based on DWG (p,q) and HOG (p,q) corresponding to the positive training image; and
providing DWGH (p,q) corresponding to each of the plurality of positive training images to the machine learning based classifier.

2. The method for training the machine learning based classifier of claim 1, wherein the machine learning based classifier is a support vector machine (SVM) classifier.

3. The method for training the machine learning based classifier of claim 1, wherein the machine learning based classifier is a neural network classifier.

4. The method for training the machine learning based classifier of claim 1, wherein an object of the one or more objects is a human body.

5. The method for training the machine learning based classifier of claim 1, wherein each of the plurality of positive training images comprises of one or more objects to be detected by the object detection system.

6. The method for training the machine learning based classifier of claim 1 further comprising normalizing the DWG (p,q).

7. The method for training the machine learning based classifier of claim 1, wherein the DWGH (p,q) is a dot product of DWG (p,q) and HOG (p,q).

8. A machine learning based classification system to be used for detecting one or more objects in an input image, the machine learning classification system being trained to detect the one or more objects, the machine learning based classification system comprising:
an image input unit configured to receive one or more training images, wherein the one or more training images comprises of a plurality of positive training images;
an image processor configured to:
divide each positive training image of the plurality of positive training images into a cell grid of size p*q, wherein each positive training image comprises of p*q cells;
compute a histogram of gradients (HOG) feature descriptor for each of the p*q cells in each of the plurality of positive training images, wherein HOG (p,q) for a positive training image represents HOG feature descriptor computed for a cell location (p,q) of the positive training image;
compute a directional weighted gradient DWG (p,q) by adding HOG (p,q) corresponding to each of the plurality of positive training images; and
compute a directional weighted gradient histogram (DWGH) feature descriptor for each of the p*q cells in each of the plurality of positive training images, wherein DWGH (p,q) for a positive training image is computed based on DWG (p,q) and HOG (p,q) corresponding to the positive training image; and
a feeder configured to provide DWGH (p,q) corresponding to each of the plurality of positive training images to a machine learning based classifier.

9. The machine learning based classification system of claim 8, wherein the machine learning based classifier is a support vector machine (SVM) classifier.

10. The machine learning based classification system of claim 8, wherein the machine learning based classifier is a neural network classifier.

11. The machine learning based classification system of claim 8, wherein an object of the one or more objects is a human body.

12. The machine learning based classification system of claim 8, wherein each of the plurality of positive training images comprises of one or more objects.

13. The machine learning based classification system of claim 8, wherein the image processor is further configured to normalize the DWG (p,q).

14. The machine learning based classification system of claim 8, wherein the DWGH (p,q) is a dot product of DWG (p,q) and HOG (p,q).

15. A computer programmable product for training a machine learning based classifier to be used with an object detection system, the object detection system being configured to detect one or more objects in an input image, the computer programmable product including a set of instructions, that when executed by a processor of the object detection system causes the processor to:
receive one or more training images, wherein the one or more training images comprises of a plurality of positive training images;
divide each positive training image of the plurality of positive training images into a cell grid of size p*q, wherein each positive training image comprises of p*q cells;
compute a histogram of gradients (HOG) feature descriptor for each of the p*q cells in each of the plurality of positive training images, wherein HOG (p,q) for a positive training image represents HOG feature descriptor computed for a cell location (p,q) of the positive training image;
compute a directional weighted gradient DWG (p,q) by adding HOG (p,q) corresponding to each of the plurality of positive training images;
compute a directional weighted gradient histogram (DWGH) feature for each of the p*q cells in each of the plurality of positive training images, wherein DWGH (p,q) for a positive training image is computed based on DWG (p,q) and HOG (p,q) corresponding to the positive training image; and
provide DWGH (p,q) corresponding to each of the plurality of positive training images to the machine learning based classifier.
